(19) United States
(12) Patent Application Publication
(10) Pub. No.: US 2013/0139762 A1
(43) Pub. Date: Jun. 6, 2013

(54) Dirt or Filler Insulated Dwelling Shelter

(71) Applicant: John Geary Loden, McGregor, TX (US)

(72) Inventor: John Geary Loden, McGregor, TX (US)

(73) Assignee: Mr. John Geary Loden, Waco, TX (US)

(21) Appl. No.: 13/310,475

(22) Filed: Dec. 2, 2011

(51) Int. Cl. A01K 1/00

(52) U.S. Cl. 119/416

(57) ABSTRACT

A shelter insulated by dirt, growing materials or a filler to protect an occupant from weather conditions or climatic temperatures. The insulated upper compartment overlaps and houses a fixed horizontal floor for supporting the occupant. The insulated structure, with an opening for egress and entrance, protects from the elements by being insulated with a physical substance. The ground floor keeps the occupant dry and clean. The upper compartment's insulation is encased in openings, by any means, a way to hold and expose the filler. Any vegetation can be embedded into the upper compartment's contained filler to help expel heat from the growing matter by evapotranspiration. The vegetation can provide additional layer insulation. This shelter's upper portion may be comprised of either, a unitary casing comprised of layers or assembled pieces in which to cover an upper structure in its entirety, and the lower horizontal base being the floor.

### FIELD OF THE INVENTION

This invention relates to a dwelling or a shelter, more particularly, for a pet shelter insulated by dirt, growing matter, vegetation or a physical substance filler to protect it's occupant from natural elements and climates.

### BACKGROUND OF THE INVENTION

Shelters and dwellings have been homemade and built by any means forever. Originally, structures were made from wood, metal, plastics or other materials, which do not provide a natural protective layer of insulation at an economical expense. Pet shelters, generally, are constructed mainly to protect against sun, wind, and precipitation, but are not normally insulated or attractive. As a result, the need for a useful insulated aesthetic shelter has developed.

For years, most shelters for pets, or even people in third world countries, particularly those in extreme climatic regions, do not offer adequate protection from severe heat or cold. All though these shelters, usually outside, shield from wind and precipitation, they are very susceptible to harsh weather temperatures.

The problem with typical shelters for pets or persons, is the lack of insulation to provide adequate protection against the summer's high temperatures and the winter's low temperatures. Single layered typical shelter's or pet dwellings made from wood, metal or molded plastic, have in fact, added degrees and act as an oven in the direct summer's heat. In winter seasons, a single layered dwelling does not provide enough protection against extreme temperatures.

### SUMMARY OF THE INVENTION

In concurrence with the current old invention, the disadvantages and problems associated with previous shelters have been substantially reduced or eliminated. One main facet of the present invention provides a shelter fully and completely insulated with dirt or a physical matter to create protection from extreme climatic temperatures.

According to the present development's description, the shelter includes a prefabricated enclosed structure, which can be of any symmetrical shape or gabled structure. Lined or stacked with a growing matter or a physical substance the structure is secured, stout and insulated. An entrance is easily accessible through a portal. Commonly, a horizontal foundation is encased underneath the shelter.

The most important technical feature is providing a shelter fully insulated by dirt or a physical substance to guard it's occupant against harsh temperatures. Southern regions can reach extreme heats of over 100 degrees, the insulated structure can provide up to a 15 degrees cooler temperature. Another added advantage is the layers of protection to shield against precipitation and wind. Occupant's body heat may be contained in the insulated present invention during winter months. Thus, the present shelter's advantage by being insulated by dirt or a filler has overcome the problem associated with previous shelters.

Further technical elements of the innovation may include developing a shelter with a duel purpose in adding an additional layer of vegetation for extra insulation and shade when shelter is filled with dirt, a growing matter or water. Yet, another benefit is gardeners can protect the shelter's occupant and possess an elevated garden simultaneously.

Other technical elements of the invention may include developing a shelter with an additional purpose by adding water, fountains, and feed to upper compartments receptacles.

Other features and benefits will become evident from the subsequent specification associated with the following drawings.

### DETAILED DESCRIPTION OF THE INVENTION

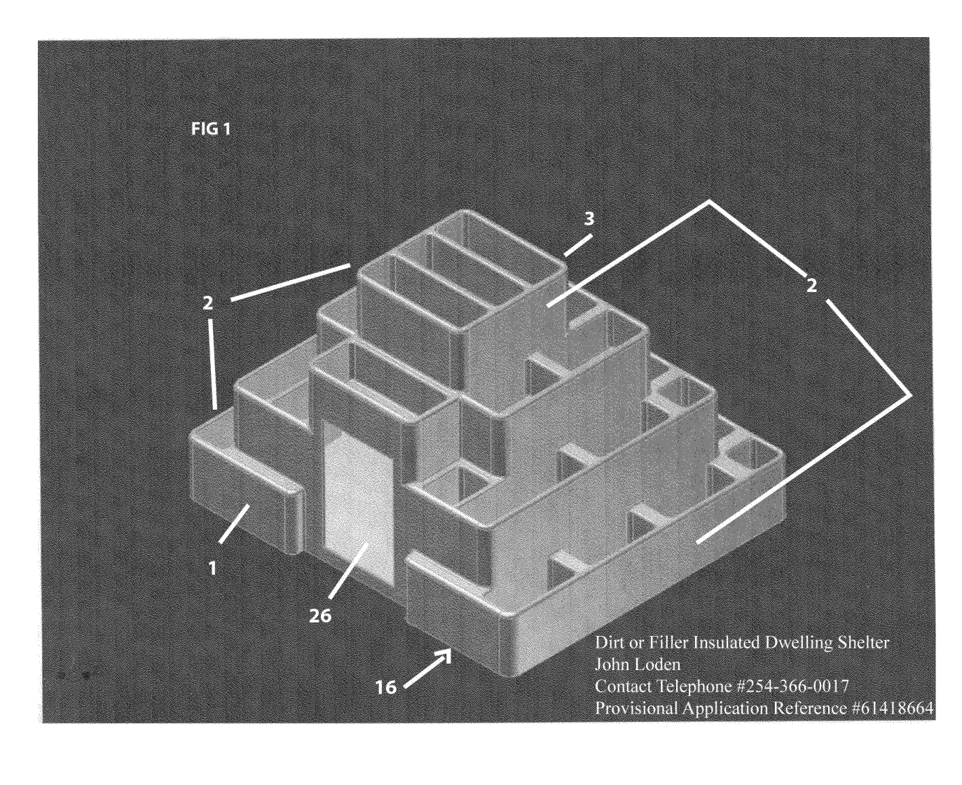

Referring to all the drawings, but in FIG. 1, the a dog house has a bottom 16, side walls 2, a back wall 3 and a front wall 1 which has an entrance generally referred to by arrow 26.

### Reference Numerals in Drawings and Photo

12 dirt and/or growing matter

14 receptacle

16 base

18 upper component's exterior wall

26 entrance and exit

28 dead air space compartment

30 upper component's interior wall

32 gaps between receptacles (can be filled with foam)

### DESCRIPTION OF THE DRAWINGS

FIG. 1 shows a plain view of the shelter in accordance with the present invention illustrating the 2 exterior upper component, 16 base and 26 entrance;

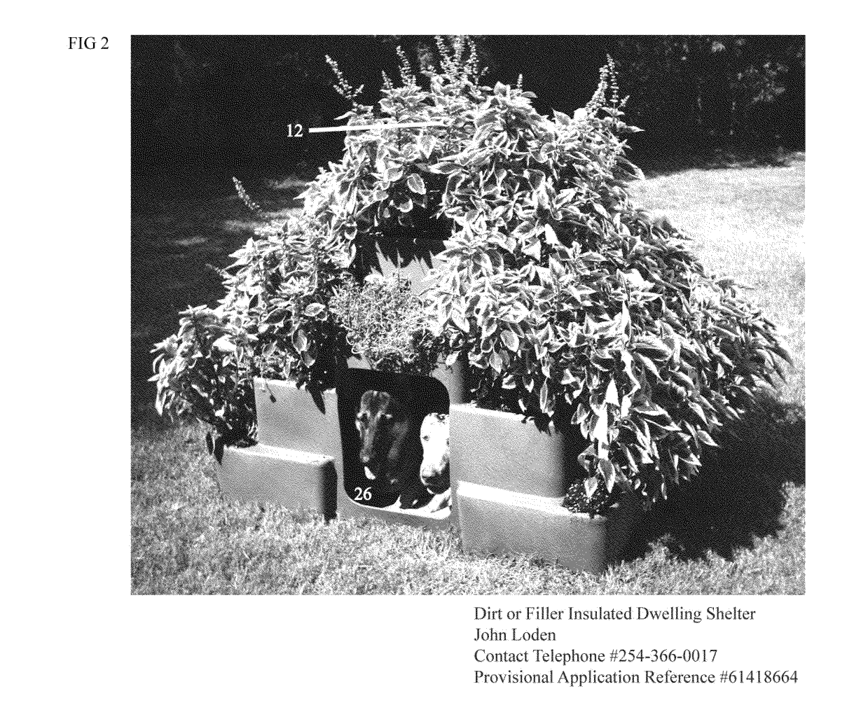

FIG. 2 shows an actual photo of the present invention actually made in accordance with the present invention showing 12 dirt and vegetation filler in the upper component from a side frontal view, which shows the occupants in the dwelling shelter via 26 the entrance.

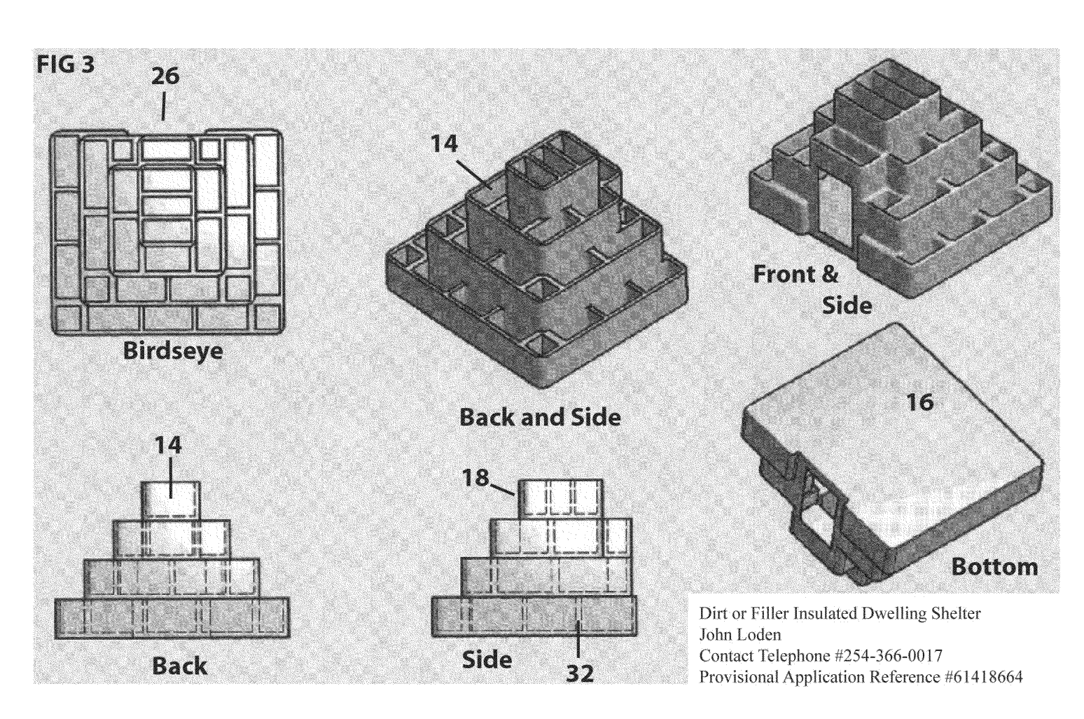

FIG. 3 shows detailed examples of the birdseye view with the 26 entrance, the 14 receptacles to hold the insulation filler, and the 16 bottom of the shelter. This is a present drawing of how the present invention is be made, used in this shape, and structured by using the same concept for insulation and protection in the claimed invention.

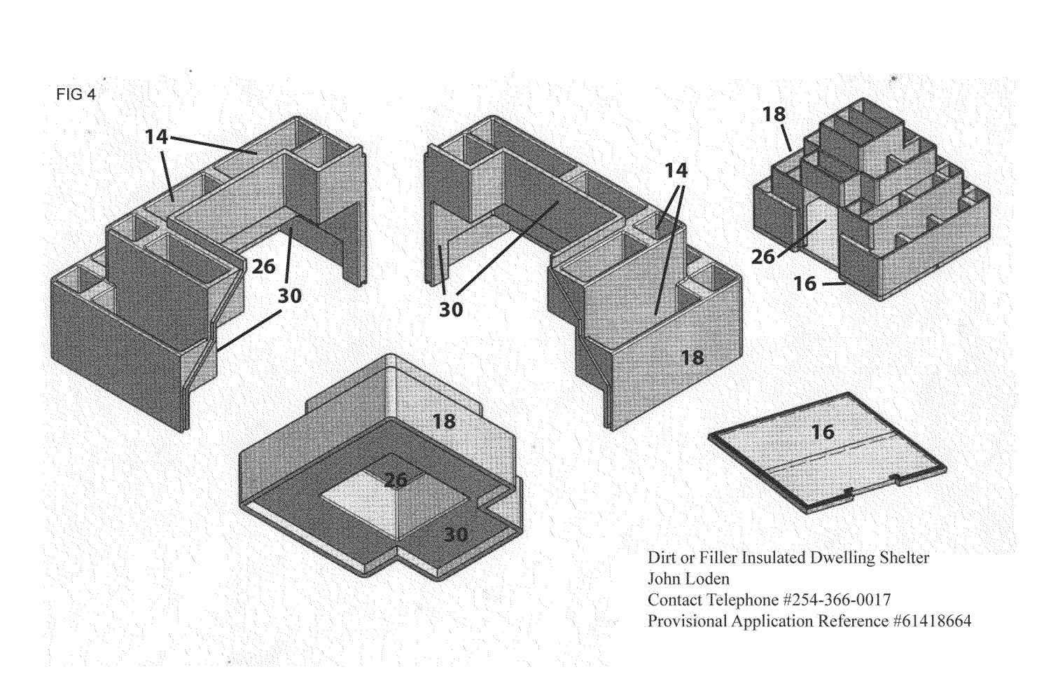

FIG. 4 shows an exploded view of the structure and how the structure could be manufactured in pieces for assembly after shipping effectively and efficiently.

### DESCRIPTION OF THE PREFERRED EMBODIMENT

The ideal embodiment of the present invention and its beneficial purpose and advantages are implicated in the FIGS. 1-4 drawings, the actual photo and in the interpretations of the various drawings on the present invention but with other designs using the same concept of the invention in the working stages.

A very well rendering of an animal or person shelter in accordance with the present invention is illustrated in the FIG. 1-4. These shelters contain: 18 upper component's exterior walls, which holds insulating 12 dirt or growing matter, or an physical substance for insulation, upper component's interior walls, a 16 base, and 30 upper compartment's interior wall which outlines the upper compartment which houses 28 dead air space, in which an occupant can dwell or rest inside.

The 26 entrance and exit, generally centered on the frontal portion of the structure for entering and exiting the shelter. A door or covering of the doorway would greatly enhance the insulating factor.

In the upper compartment 14 receptacles or crevices which are filled with soil or growing matter in this present invention, various types of 12 vegetation can yield not only aesthetically pleasing crops, but also added characteristics such as shade, color, and evapotranspiration qualities to help radiate the filler temperatures. Herbs, seasonal color or ground cover can add an extra layer of insulation with this method of insulation. Water and/or fountains can be substituted and/or desired instead, using the 14 receptacles for water bowls, watering systems, bird baths or eye pleasing fountains. 14 Receptacles can also be used for food containers to feed birds seed or food for pets.

When present invention is used dually as a gardening arrangement and shelter, indoors or outdoor, drainage holes can aid in the vegetation growth process by expelling moisture from within the 14 receptacles and out through the 18 upper component's exterior walls.

When the present invention uses 32 gaps filled with foam as the 30 upper compartment's interior walls, the foam can provide added strength and form.

It is obvious that other changes and alterations can be made to this invention as specifically described and still be within the spirit and scope of this invention as described in the specification and appended claims.

Changes may be made in combination and arrangement of elements as hereto for set forth in the specification and shown in the drawings; it being understood that changes may be made in the embodiments disclosed without departing from the spirit and scope of the invention as defined in the following claims.

I claim:

1. A dwelling structure or shelter, comprising:
a base or a bottom layer;
an enclosed upper compartment shelters the base; the upper component provides a compartment to house an occupant or animals;
the upper compartment protects the occupant within the structure;
the said upper structure's portion contains permanent multiple hollowed crevices which hold an insulating dirt, filler, physical substance or a growing matter, completely covering and insulating the upper portion of the structure;
an opening in the structure provides a means of entering and exiting for the dweller through the upper compartment.

2. The dwelling structure in claim 1, further comprising drainage holes in the upper structure's crevices or receptacles, which allow moisture to escape and drain outside the structure's exterior casing. The interior casing lines and protects occupant from moisture by being a non-porous shield.

3. The dwelling structure in claim 1, may further comprise a facing of hollowed multiple crevices uniformly apart of, made up of, or positioned onto the exterior upper portion covering it in its entirety, which is to be filled with a physical substance or dirt supported by a inner lining.

4. The dwelling structure in claim 1, further comprising homogeneously receptacles containing growing matter for means of evapotranspiration by any vegetation embedded into the dirt or filler contained in the upper compartment to help radiates and expels the heat from the growing matter or dirt. In warmer climates, evapotranspiration keeps the shelter's interior cooler by radiating the temperature and shading from the vegetation. Vegetation can add additional layer of insulation and protection.

5. The dwelling structure in claim 1, may used in conjunction with an additional means to include a door to the entrance by a cloth like or plastic material flaps fastened to the entrance in the shelter's upper portion for added protection.

6. The dwelling structure in claim 1, further comprising homogeneously receptacles in the upper portion containing water can act as water bowls for pets, bird baths or a receptacle for a water fountain.

7. The dwelling structure in claim 1, further comprising homogeneously receptacles in the upper portion containing bird seed or pet food can act as food feeder containers.

8. The dwelling structure in claim 1, further comprising homogeneously receptacles in the upper portion containing physical substance can add weight to sturdy and prevent structure's mobility.

9. The dwelling structure in claim 1, further comprising foam, as an interior wall or the inner lining, which may give strength and solid support the structure and frame in the upper component's composition.

10. The dwelling structure in claim 1, can be sized in various sizes to further accommodate, in the upper portion, a number of occupants depending on the size.

11. The dwelling structure in claim 1, further comprising materials, in the upper portion, sandwiching or encasing dirt or matter for insulation purposes.

12. The dwelling structure in claim 1, further comprising, in the upper portion, a full terraced receptacle to mound dirt and hold substance in place.

13. The upper compartment in claim 1, can exhibit symmetry in synthetic structural form in various shapes and be comprised in block formation or in handling pieces;

14. The upper compartment in claim 1, can be constructed in the ziggurat shape is high winds proof;

15. The upper compartment in claim 1, can be in pieces to be constructed and designed in a shape to be stacked for shipping and easy transporting;
